(19) United States
(12) Patent Application Publication
(10) Pub. No.: US 2010/0040731 A1
(43) Pub. Date: Feb. 18, 2010

(54) ARABINOXYLO-OLIGOSACCHARIDES IN BEER

(76) Inventors: Guido Aerts, Lovendegem (BE); Willem Broekaert, Dilbeek (BE); Christophe Courtin, Wilsele (BE); Jan Delcour, Heverlee (BE)

Correspondence Address: CLARK & ELBING LLP, 101 FEDERAL STREET, BOSTON, MA, 02110, US

(21) Appl. No.: 12/541,631

(22) Filed: Aug. 14, 2009

Related U.S. Application Data
(63) Continuation-in-part of application No. PCT/BE2008/000011, filed on Feb. 14, 2008.
(60) Provisional application No. 60/901,482, filed on Feb. 15, 2007.

(30) Foreign Application Priority Data
Feb. 14, 2007 (GB) 0702844.2

(51) Int. Cl. C12G 3/08

(52) U.S. Cl. 426/14; 426/592

(57) ABSTRACT

This invention provides beers with increased amounts of soluble arabinoxylans having an average degree of polymerisation (DP) below 50 for improving or significantly altering their mouthfeel. This invention also provides methods for enriching a wort or beer with such soluble arabinoxylans during the brewing process.

### CROSS REFERENCE TO RELATED APPLICATIONS

This application is a continuation-in-part of the National Stage of International Application No. PCT/BE2008/000011, filed Feb. 14, 2008, which was published in English under PCT Article 21(2), and which claims the benefit of British patent application No. 0702844.2, filed Feb. 14, 2007, and of U.S. provisional patent application No. 60/901,482, filed Feb. 15, 2007, the disclosures of which are incorporated by reference in their entirety.

### FIELD OF THE INVENTION

The present invention relates to beers and fermented beverages including high amounts of low molecular weight soluble arabinoxylans. The present invention also relates to methods for increasing the level of soluble arabinoxylo-oligosaccharides in beer and fermented beverages, in order to improve or significantly alter the taste and/or mouthfeel of such beer or fermented beverage. Moreover, the present invention relates to bottom-fermented, top-fermented, low-alcohol and non-alcoholic beers enriched with soluble arabinoxylo-oligosaccharides.

### BACKGROUND OF THE INVENTION

Beer is a fermented beverage rich in calories due to the relatively high concentration of alcohol and digestible carbohydrates, in particular maltodextrins, maltose, and glucose. Digestible carbohydrates end up in beer as a result of incomplete degradation of starch into maltose and glucose and/or the incomplete fermentation of maltose and glucose into alcohol. Reduction of the caloric content of beers, whether by reducing the alcohol content and/or the content in digestible carbohydrates, usually brings a loss in taste and/or mouthfeel that is perceived negatively by most consumers. In the production of low calorie beers and low alcohol beers the challenge is to find a balance between lowering the level of digestible carbohydrates and maintaining a sufficiently acceptable level of taste and/or mouthfeel that is normally contributed by these carbohydrates. There is a need in the art for finding a solution to this problem at a relatively moderate production cost and, if possible, without significantly altering the sequence of steps, or significantly increasing the number of steps, of standard beer brewing processes.

Table 1 gives an overview of the soluble arabinoxylan (abridged as AXOS) content, according to the determination method described below, in different commercially available beers. Table 1 shows that most beers comprise a limited amount of soluble arabinoxylans (having an average degree of polymerisation from 8 to 25), typically not more than 0.8 g/l for low alcohol-content beers, not more than about 2.0 g/l for medium alcohol-content beers (i.e. beers with an alcohol content from 3.5 to 6% by volume) and not more than about 2.15 g/l for high alcohol-content beers (i.e. beers with an alcohol content above 6% by volume). Moreover, table 1 shows that the concentration of said low molecular weight soluble arabinoxylans significantly varies according to the type of beer, in particular the alcohol content (per volume) and the real extract (as defined below). An analogous degree of variation of arabinoxylan content according to the type of beer was previously observed by Schwarz and Han (1995) in J. Am. Soc. Brew. Chem. 53(4):157-159 using a gas chromatography method for the determination of arabinoxylan content in beer.

### SUMMARY OF THE INVENTION

The present invention is based on the finding that the concentration of soluble arabinoxylans, mainly low molecular weight arabinoxylo-oligosaccharides, is a determining parameter for the taste and/or mouthfeel of beers and other fermented beverages, especially bottom fermented beers, low alcohol beers and non-alcoholic beers. Moreover, it was found that the taste and/or mouthfeel of a beer or another fermented beverage is significantly improved or altered by significantly increasing the concentration of soluble arabinoxylo-oligosaccharides (hereinafter referred as AXOS, with structures shown in FIG. 1 of EP-1.418.819-B1, herein incorporated by reference) with an average degree of polymerization below 50 (preferably from 3 to 40) in said beer or other fermented beverage above a certain level, in particular above their current concentration in commercially available beers. AXOS usually exists as a heterogeneous mixture of related oligosaccharides differing from each other in the degree of polymerization (hereinafter referred as DP) of the beta-1,4-xylose-backbone and/or the degree of substitution (DS) of the beta-1,4-xylose-backbone by arabinose units. AXOS can also carry substitutions, on either the xylose or arabinose units, by residues such as, but not limited to, 4-O-methylglucuronic acid, acetic acid, ferulic acid and/or p-coumaric acid. AXOS can also differ by their arabinose/xylose (abridged as A/X) ratio in the molecule. AXOS can be derived from arabinoxylan (as defined below, i.e. a polysaccharide) by partial hydrolysis, e.g. either using acids or endoxylanase enzymes. Arabinoxylan, also frequently referred to as pentosan (because it is composed of the pentose-type monosaccharides xylose and arabinose), has the same composition as AXOS, except that the polysaccharide chains are much longer, typically with a DP of 5,000 or higher. Arabinoxylan and AXOS are non-digestible carbohydrates. Whole barley and wheat grains, the raw material used traditionally for beer making, are particularly rich in arabinoxylan, and may contain up to 6-10% by weight of this polysaccharide. During traditional beer brewing, the major part of the arabinoxylans are not extracted from the grains and remain in the spent grain residue after the lautering step. Soluble arabinoxylans with an average DP above 50 are known to produce serious problems in beer brewing, including reduced rates of wort separation, low recovery rates of malt extract, shortened filter life, and diminished rates of beer filtration.

The present invention relates to a method for enhancing by at least about 5%, e.g. at least 15%, preferably at least 20%, more preferably at least 30%, most preferably at least 40%, for instance at least 50%, the content of soluble arabinoxylo-oligosaccharide (i.e. AXOS with an average degree of polymerization below 50, preferably from 3 to 40) in a beer or a fermented beverage with respect to the current AXOS content of commercially available beers or fermented beverages. This AXOS content enhancement may be achieved in different ways, e.g. by degradation of arabinoxylans from cereals during beer preparation through exogenously added enzymes, or by supplementation of wort or beer with externally produced arabinoxylo-oligosaccharides, in particular soluble arabinoxylans having an average degree of polymerization below 50, preferably from 3 to 40. In one embodiment of the present invention, the exogenously added enzymes used during beer preparation are one or more endoxylanases. In another embodiment of the present invention, the externally produced soluble arabinoxylo-oligosaccharides supplemented to wort or beer may be derived from natural sources such as plant material, and more preferably from cereals, in a manner known to the skilled person. The beers and fermented beverages according to this invention, with increased levels of arabinoxylo-oligosaccharides, in particular soluble arabinoxylans having an average degree of polymerization below 50, preferably from 3 to 40, exhibit a significantly improved or altered taste and/or mouthfeel.

### BRIEF DESCRIPTION OF THE DRAWINGS

FIG. 1 shows the result of a sensorial analysis of a commercial beer (Bud Light) to which either 2 g/l or 10 g/l of soluble AXOS was added according to the present invention. Bars represent mean of the scores and error bars indicate the standard deviation. Bars with a different letter are significantly different from each other according to Friedman's ANOVA test at p<0.05.

FIG. 2 shows the result of a sensorial analysis of two experimental beers, brewed from the same wort, before (for comparative purpose) and after soluble AXOS enrichment according to the present invention. Bars represent mean of the scores and error bars indicate the standard deviation. Bars with a star show a significant difference from the corresponding value according to Wilcoxon's signed rank test at p<0.05.

### DETAILED DESCRIPTION OF THE INVENTION

Analysis of the soluble arabinoxylan content in different commercially available beers showed that most beers comprise a limited amount of soluble arabinoxylans, typically less than about 2.0 g/l. The concentration of said soluble arabinoxylans varies according to the type of beer as shown in table 1 below, however based on their soluble arabinoxylan content the currently commercially available beers can be divided into two distinct groups.

A first group comprises beers which are typically produced by bottom fermentation of a low gravity wort or a diluted wort, or by dilution of a bottom fermented wort, and which comprise less than 0.75 g soluble arabinoxylans per litre. Within said first group two distinct types of beer can be identified:
(i) beers comprising less than 3.5% (v/v) alcohol, preferably less than 1.5% (v/v), more preferably less than about 0.6% (v/v), for instance less than about 0.05% (v/v) and generally referred to as low alcohol beers or “alcohol free” beers; the maltodextrin content in this type of beer may be quite high, typically at least 30 g per litre; and
(ii) beers comprising more than 3.5% (v/v) alcohol but comprising less than 3 g real extract per 100 ml, preferably less than 2.5 g per 100 ml, and generally referred to as low calorie beers or “light” beers; typically, the maltodextrin content in this type of beer is less than about 15 g per litre.

A second group comprises beers having an alcohol content above 3.5% (v/v) and which comprise more than about 3 g real extract per 100 ml. Beers comprised in this second group typically comprise between about 0.7 and about 2.0 g of soluble arabinoxylans per litre and within said group two main types of beer can be identified:
(i) Lager beers produced by bottom fermentation, such as Pilsner style beers Many of these beers comprise between 3.5% and 6% (v/v) alcohol and between 3.0 and 5.0 g real extract per 100 ml. However, lager beers comprising more than 6% (v/v) alcohol and/or more than 5.0 g real extract per 100 ml may also be commercially available.; and
(ii) Top fermented beers that comprise more than 3.5% (v/v) alcohol and more than 3.0 g real extract per 100 ml. They may comprise up to about 12.0% (v/v) alcohol and/or up to 9.0 g real extract per 100 ml.

The present invention is based on the finding that increasing by at least about 5% the concentration of soluble arabinoxylans in a beer or other fermented beverage significantly enhances or alters the taste and/or mouthfeel of said beer or fermented beverage. Therefore, in a first object the present invention provides a method to improve or alter the taste and/or mouthfeel of a beer (especially including each of the above classified types of beer) or other fermented beverage by increasing by at least about 5%, for instance by at least about 20% or about 30%, such as at least 40% or at least 50%, and/or up to about 150% or more, the concentration of soluble arabinoxylans above the concentration obtained as the result of a normal brewing process as presently known in the art. The increased levels of soluble arabinoxylans in the wort or beer do not negatively affect the main parameters (such as number and duration of steps) or the global efficiency of the brewing process when such soluble arabinoxylans have an average degree of polymerisation (DP) below 50. Moreover, sensorial analysis of the beers enriched with such soluble arabinoxylans having a DP below 50 do not reveal any undesired increase of the perceived viscosity of the beer. Therefore, the present invention provides the enrichment of beers or other fermented beverages with soluble arabinoxylans having an average DP lower than 50, preferably with a DP between 3 and 40, more preferably between 3 and 30, for instance between 5 and 20. According to one embodiment, the average DP of soluble arabinoxylans comprised in the beer or other fermented beverage of the present invention is at least about 3, for instance at least about 4, or at least about 5. According to one embodiment, the average DP of soluble arabinoxylans comprised in the beer or other fermented beverage of the present invention is at most about 40, for instance at most about 30, or at most about 20.

In a first embodiment, the present invention relates to a method for the improvement or alteration of the taste and/or mouthfeel of a beer resulting from a bottom fermentation process, which beer either comprises an alcohol level below 3.5% (v/v) or a real extract below 3.0 g per 100 ml, by enriching said beer with soluble arabinoxylans as described herein-above, thus resulting in a concentration of more than 1.2 g soluble arabinoxylans with an average DP below 50, preferably an average DP between 3 and 40, more preferably an average DP between 3 and 30, for instance an average DP between 5 and 20, per litre of bottom fermented beer. For instance the concentration of soluble arabinoxylans with an average DP as specified herein-above may be more than 1.4 g per litre, preferably more than 1.6 g per litre, more preferably more than 1.8 g per litre, and most preferably more than 2.0 g per litre, such as for instance more than 3.0 g per litre or even more than 4.0 g per litre, and up to about 20 g per litre. In an embodiment of the present invention, said beer is a so-called low alcohol or “alcohol-free” beer comprising less than 3.5 % (v/v) alcohol, preferably less than 1.5% (v/v) alcohol, more preferably less than 1.0% (v/v) alcohol, for instance less than 0.5 or less than 0.05% (v/v) alcohol. In another preferred embodiment of the present invention said beer is a so-called low calorie or “light” beer comprising less than 3.0 g per 100 ml real extract, more preferably less than 2.0 g per 100 ml real extract.

In a second embodiment the present invention relates to a method for the improvement or alteration of the taste and/or mouthfeel of a beer comprising an alcohol level between 3.5 and 6% (v/v) alcohol and a real extract between about 3.0 and 5.0 g per 100 ml, by enriching said beer with soluble arabinoxylans in a manner as described herein-above, thus resulting in a concentration of more than about 2.0 g soluble arabinoxylans with an average DP below 50, preferably an average DP between 3 and 40, more preferably an average DP between 3 and 30, for instance an average DP between 5 and 20, per litre beer. For instance the concentration of soluble arabinoxylans with an average DP as specified herein-above may be more than 2.5 g per litre, preferably more than 3.0 g per litre, more preferably more than 3.5 g per litre, most preferably more than 4.0 g per litre, such as for instance more than 4.5 g per litre or more than 5.0 or 6.0 g per litre, and up to about 25 g per litre beer. In one embodiment of the present invention said beer is produced by using a bottom fermentation process well known in the art. Preferably, such beers obtained by bottom fermentation are enriched with soluble arabinoxylans in a manner as described herein, thus resulting in a concentration of more than about 2.0 g soluble arabinoxylans with an average DP below 50, preferably an average DP between 3 and 40, more preferably an average DP between 3 and 30, for instance an average DP between 5 and 20, per litre beer. For instance the concentration of soluble arabinoxylans with an average DP as specified herein-above may be more than 2.5 g per litre, preferably more than 3.0 g per litre, more preferably more than 3.5 g per litre, most preferably more than 4.0 g per litre, such as for instance more than 4.5 g per litre or more than 5.0 or 6.0 g per litre, and up to about 25 g per litre beer.

In another embodiment of the present invention said beer is produced by using a top fermentation process well known in the art. Preferably, such beers obtained by top fermentation are enriched with soluble arabinoxylans in a manner as described herein, thus resulting in a concentration of more than about 2.0 g soluble arabinoxylans with an average DP below 50, preferably an average DP between 3 and 40, more preferably an average DP between 3 and 30, for instance an average DP between 5 and 20, per litre beer. For instance the concentration of soluble arabinoxylans with an average DP as specified herein-above may be more than 2.5 g per litre, preferably more than 3.0 g per litre, more preferably more than 3.5 g per litre, most preferably more than 4.0 g per litre, such as for instance more than 4.5 g per litre or more than 5.0 or 6.0 g per litre, and up to about 25 g per litre beer. In a particular embodiment such beers obtained by top fermentation are enriched with said soluble arabinoxylans, thus resulting in a concentration of more than about 7.0 g, more preferably more than 8.0 g, of said soluble arabinoxylans per litre beer and up to about 25 g per litre beer.

In a further embodiment the present invention relates to a method for the improvement or alteration of the taste and/or mouthfeel of a beer comprising an alcohol level higher than 6% (v/v) alcohol and a real extract higher than 5.0 g per 100 ml, by enriching said beer with soluble arabinoxylans in a manner as described herein-above, thus resulting in a concentration of more than 2.4 g soluble arabinoxylans with an average DP below 50, preferably an average DP between 3 and 40, more preferably an average DP between 3 and 30, for instance an average DP between 5 and 20, per litre beer. The concentration of soluble arabinoxylans with an average DP as specified herein-above may be preferably more than 3.0 g per litre, more preferably more than 4.0 g per litre, such as for instance more than 5.0 g per litre or more than 6.0 g per litre, and up to about 30 g per litre beer. In a preferred embodiment said beer is produced by using a bottom fermentation process well known in the art. In another preferred embodiment said beer is produced by using a top fermentation process well known in the art.

With respect to each of the above-specified embodiments of the present invention, it may be useful to select soluble arabinoxylans which exhibit an arabinose/xylose ratio of at least 0.3, and/or an arabinose/xylose ratio of at most 0.5.

The soluble arabinoxylan concentration in beer samples is preferably determined as follows. A beer sample is first decarbonated by sonication for 10 minutes followed by filtration through a standard paper membrane. 2.5 ml of said decarbonated beer sample is mixed with 2.5 ml 4.0 M trifluoroacetic acid (2.0 M final concentration) and incubated at 110° C. for 60 minutes. After hydrolysis, the mixture is filtered and 3.0 ml of the filtrate is further treated by adding 1.0 ml of an internal standard solution (100 mg beta-D-allose in 100 ml of a 50% saturated benzoic acid solution), 1.0 ml of ammonia solution (25% v/v) and 3 drops of 2-octanol. The monosaccharides are reduced to alditols by addition of 200 μl of a sodium borohydride solution (200 mg sodium borohydride in 1.0 ml 2M ammonia) and the sample is incubated for 30 minutes at 40° C. The reaction is stopped by addition of 400 μl of glacial acetic acid. For the acetylation reaction, 500 μl of the sample containing the alditols is added to 5.0 ml of acetic anhydride and 500 μl of 1-methyl-imidazole. After 10 minutes, the excess of acetic anhydride is removed by addition of 900 μl ethanol to the sample. Alditol acetates are then concentrated in the organic phase by addition of water (10 ml) and potassium hydroxide solution (2 times 5.0 ml of 7.5 M solution, with an intermediate rest of a few minutes). Bromophenol blue solution (500 μl, 0.04% w/v) is added as indicator for the aqueous phase. Aliquots of 1 μl of the organic phase containing the formed alditol acetates are separated by gas chromatography on a suitable polar column (for instance, a Supelco SP-2380 column, 30 m×0.32 mm; 0.2 μm film thickness, commercially available from Supelco, Bellefonte, Pa., USA) in a chromatograph (for instance Agilent 6890 series, Wilmington, Del., USA) equipped with a flame ionisation detector. Purified monosaccharides D-xylose, L-arabinose and optionally D-galactose are treated in parallel with each set of samples for calibration purposes.

For the purpose of the present invention the content of soluble arabinoxylans in the beer samples is preferably calculated using the formula

(1): soluble arabinoxylan content=0.88×(% arabinose+ % xylose) (1).

However, the skilled person is aware that in some prior art arabinoxylan content is sometimes corrected for the arabinogalactan content by using formula (2):

soluble arabinoxylan content_{corr}=0.88×(% arabinose−0.7× % galactose+ % xylose) (2).

The enrichment of beers by at least 5%, preferably at least 20%, more preferably at least 30%, most preferably at least 40%, for instance at least 50% with soluble arabinoxylans having the desired DP as specified herein-above may be obtained by making use of, i.e. by adding, a preparation comprising soluble arabinoxylans as an ingredient in the brewing process. Preferably said arabinoxylan-containing preparation is derived from cereals, such as for instance wheat, rye, barley, oats, triticale, rice, millet, sorghum or maize, and may comprise more than about 15% (w/w) arabinoxylan having an average DP lower than 50, preferably with an average DP between 3 and 40, more preferably an average DP between 3 and 30, for instance an average DP between 5 and 20. Preferably the cereal-derived preparation may comprise more than 30% (wlw), more preferably more than 40% (w/w), for instance more than 50% (w/w) of such soluble arabinoxylans. As a complement up to 100% (w/w) of their global composition, such cereal-derived preparation may further comprise from about 5 to 20% (w/w) other polysaccharides (e.g. manno- and galactosaccharides, β-glucans and/or maltodextrins amongst others), from about 5 to 20% (w/w) disaccharides, from about 0.1 to 5% (w/w) monosaccharides and/or from about 0.1 to 10% (w/w) proteins. In a suitable embodiment, the method of the present invention comprises the addition of said soluble arabinoxylan-containing preparation as an adjunct or additive during any one of the mashing, wort boiling, wort cooling, fermentation or post-fermentation steps (each of them being as defined herein-below) of the brewing process of a beer. If said soluble arabinoxylan-containing preparation is used as an additive for providing the taste and/or mouthfeel ingredient of this invention in the production of a low alcohol or low-calorie beer, advantageously said preparation should not comprise significant or high levels of fermentable or metabolisable carbohydrates.

Alternatively, the enrichment of beers by at least 5% preferably at least 20%, more preferably at least 30%, most preferably at least 40%, for instance at least 50% with soluble arabinoxylans having the desired average DP may be obtained by using an endoxylanase preparation comprising a single endoxylanase or a combination of different types of endoxylanases during any one of the mashing, wort boiling, wort cooling, fermentation or post-fermentation steps (each of them being as defined herein-below) of the brewing process. Preferably, said endoxylanase or combination of endoxylanases are selected such as to promote solubilisation of both the water-extractable and water-unextractable arabinoxylans from the arabinoxylan-containing brewing ingredients, such as the malted cereal grains, non-malted cereal grains, or cereal grain-derived fractions. Preferably, the addition of a given amount of an endoxylanase preparation should result in a 30%, more preferably a 40%, for instance a 50% higher presence of soluble arabinoxylans in a wort as compared to a wort prepared in absence of any added endoxylanase. The suitability of a given concentration of an endoxylanase or combination of endoxylanases for enriching a beer with soluble arabinoxylans according to the present invention can be determined as follows:
preparing a mash at 45° C. comprising 200 g grist/l water, said grist can for instance comprise 100% barley malt or 80% barley malt and 20% wheat malt;
adding the said endoxylanase preparation at a given concentration;
incubating the mash at 45° C. during 2 hours;
heating the mash to 70° C. at a rate of 1° C. per minute and maintaining the mash at 70° C. for 60 minutes;
lautering of the wort by filtration followed by boiling of the liquid fraction during 30 minutes;
obtaining a sample for soluble arabinoxylan analysis after centrifugation (10,000 g, 15 min) of the boiled wort to remove suspended particles;
determining the soluble arabinoxylans in said wort sample and comparing the soluble arabinoxylan content in said sample with the soluble arabinoxylan content in a control wort sample prepared as described above but in absence of any added endoxylanases. In case the concentration of soluble arabinoxylans in the sample comprising the endoxylanase or combination of endoxylanases is more than 25%, more preferably more than 30%, most preferably more than 40%, for instance more than 50% higher than in the control sample it can be decided that the endoxylanase or combination of endoxylanases at the tested concentration is suitable for enriching a beer with soluble arabinoxylans according to the present invention.

The one or more endoxylanases are preferably added during mashing, however, it may be beneficial to also add an endoxylanase during any other step of the brewing process such as wort boiling, wort cooling, fermentation and post-fermentation. If more than one type of endoxylanase is used in the brewing process, the different types of endoxylanases can either be added simultaneously or each type of endoxylanase can be added during a different step of the brewing process. As it is particularly important to solubilise the water-unextractable arabinoxylans comprised in the malted grains in order to increase the total concentration of soluble arabinoxylans in the beer, it is advantageous that in the mashing step of the brewing process at least one endoxylanase is added that is capable of readily solubilizing water-unextractable arabinoxylans, such as a glycoside hydrolase family 11-endoxylanase. Furthermore, it was found that due to the presence of inhibitors of endoxylanases in cereals some endoxylanases, including family 11 endoxylanases, were ineffective in solubilising relevant amounts of arabinoxylans. Therefore, it is preferred that one or more of the added endoxylanases are selected to be less easily inhibited by the kind of endoxylanase inhibitors frequently present in cereals.

In addition hydrolysis and/or solubilisation of the arabinoxylans comprised in the malted grains is usually enhanced when at least one endoxylanase of said one or more endoxylanases remains active within the full range of temperatures used during the mashing step and lautering step, said temperatures typically varying from about 40° C. to about 80° C., preferably between 45° C. and 78° C., for instance between 60° C. and 72° C.. In addition, it is advantageous that at least one endoxylanase of said one or more endoxylanases exhibits at 72° C. an enzymatic activity corresponding to not less than 20% of its enzymatic activity within the optimal temperature range for said enzyme in a cereal-based mash.

In a particular embodiment of this invention, the addition or use of endoxylanase(s) suitable for solubilising water-unextractable arabinoxylans may be combined with the addition of a material comprising relevant amounts of water-unextractable arabinoxylans, such as seed hull, seed bran or bran-derived material, to the brewing ingredients. Said hull, bran or bran-derived material can for instance be obtained as milling fractions of cereal grains such as wheat, rye, barley, oats, triticale, rice, millet, sorghum or maize. The weight ratio of the bran or bran-derived materials to the malted or non-malted grains in the grist is preferably more than about 1:30, more preferably more than about 1:20, for instance more than about 1:15. In this embodiment of the invention, the enrichment of the beer with soluble arabinoxylans results from solubilisation and fragmentation of the arabinoxylans comprised in the malted grains and the added arabinoxylan-containing material.

The enrichment of beers with soluble arabinoxylans according to the present invention can also be obtained by using enzyme mixtures exhibiting, next to endoxylanase activity, one or more additional enzyme activities selected from the group of α-L-arabinofuranosidases (which cleave off the arabinose side chains from arabinoxylan), methyl glucuronidases (which remove methyl glucuronic acid side chains thereof), feruloyl esterases (which hydrolyse the ester bond between ferulic acid and arabinoxylan), beta-glucanases (which hydrolyse beta-glucans that can be associated with arabinoxylan) and/or cellulases (which hydrolyse cellulose that can be associated with arabinoxylan).

It is generally known that rye and rye malt comprise relatively high amounts of arabinoxylans. Therefore, it may be considered to combine the use of endoxylanase(s) for the production of beers according to the present invention with the use of a grist comprising rye or rye malt. However, it was observed that the use of rye or rye malt was or may be associated with problems in the downstream brewing steps, such as lautering and filtration, particularly in combination with an endoxylanase preparation according to the present invention. Therefore, it is preferred that the grists of the beers prepared according to the present invention comprises no or only limited amounts, for instance less than 25%, more preferably less than 15%, such as less than 10% of rye, rye malt or rye-derived grist.

A second object of the invention provides beers obtainable or obtained according to the methods of soluble AXOS enrichment of the present invention.

One considerable advantage of the process of the present invention over the use of other carbohydrates, including inulin, lactosucrose, lactulose, raffinose, stachyose, arabinogalactans, resistant starch, isomaltose and/or tagatose, is that soluble arabinoxylans with a degree of polymerization below 50 (AXOS) is already naturally present at detectable levels in many, if not all, types of beer. This means that the process of the present invention does not introduce a compound that is foreign to regular beer, but merely increases its content until a unique mouthfeel and/or taste effect is obtained. As AXOS is already present in beers and can be extracted from wheat or barley, i.e. ingredients that are typically used for beer making, the process of the present invention complies with all regulatory requirements of beer brewing in most, if not all, countries, and in particular complies with the German “purity law”.

Another advantage of the process of the present invention over the use of xylo-oligosaccharides (hereinafter referred as XOS) as an additive to beer, is that AXOS, in contrast to XOS, is non-sweet and therefore suits better the taste requirements of beer. It has been demonstrated that XOS is about 30% as sweet as sucrose, whereas AXOS has less than 10% of the sweetness of sucrose. Moreover, XOS has a very high price level that precludes its use in a bulk product such as beer, whereas AXOS can either be produced in situ during brewing by addition of the appropriate enzymes, or added as a product that is very cheap to manufacture for instance as an extract from bran or as a by-product of the industrial starch/gluten separation.

Another advantage of the process of the present invention over the known methods for increasing the content of non-digestible carbohydrates in beer, is that no single change in the brewing process is required except for the simple addition of one or more suitable endoxylanases, or the simple addition of an AXOS-rich ingredient at the appropriate doses during the mashing, boiling, cooling, fermentation and/or post-fermentation steps. Furthermore, in contrast to certain methods known in the art, the process of the present invention does not entail an increase in the content of digestible carbohydrates.

In the present invention, the term “beer” refers to any fermented beverage made from cereal grains, preferably barley, wheat, triticale, oat, rye, maize, sorghum, millet or rice, as well as milled cereals or malt produced from such cereal grains, with or without addition of parts or extracts from aromatic plants such as hops, coriander, juniper, bay, rosemary, ginger, mint, licorice, yarrow, anis, or citrus, and with or without addition of fruits or fruit extracts. The term beer as used herein is meant to include, without limitation, ale, strong ale, mid ale, bitter ale, pale ale, sour ale, stout, porter, lager, malt liquor, barley wine, happoushu, bock, doppelbock, Kölsch beer, Münchener beer, Dortmunder beer, Düsseldorfer alt beer, Pilsener beer, märzen beer, German weizenbier, Berliner weisse, Saisons beer, abbey beer, Trappist beer, gueuze, Iambic beer, fruit beer, Belgian white beer, high alcohol beer, low alcohol beer, non-alcoholic beer, low calorie beer, light beer, and the like.

The steps involved in beer brewing can differ to some extent according to the beer style but generally they consist of the following major ones:
“Malting” involves the germination of cereal grains by steeping and soaking in water to allow sprouting. During sprouting several types of enzymes are produced, including those (notably α-amylase and β-amylase) that catalyze the conversion of starch into simple, fermentable sugars. The germinated grains are then dried and optionally roasted (a process called “kilning”) to kill the sprouts and to provide the grain with roasted grain flavors and color. Grains treated this way are called malted grains or simply “malt”. The malt is milled or crushed to crack or break apart the grains and to remove the sprouts, which allows the content of the malted grains to be better exposed to water during the following mashing and boiling steps.
“Mashing” involves the mixing of grist, i.e. the milled malted grains with or without adjuncts, with water, to obtain the so-called “mash”. Adjuncts are carbohydrate-rich ingredients added to the grist other than milled malted grains. The mash is heated to reach more optimal temperatures for the activity of malt enzymes or exogenously added enzymes. Mashing is typically executed at temperatures ranging from about 45° C. to about 75° C.. Mashing usually takes 1 to 2 hours, and during this time various waiting periods activate different enzymes depending upon the type of malt being used, its modification level, and the desires of the brewmaster. During mashing oligosaccharides, disaccharides and monosaccharides are generated by enzymatic breakdown of complex carbohydrates, mainly starch. Such simple sugars form a carbon and energy source for the microorganisms during fermentation.
“Lautering” involves the separation of the mash into a liquid extract, called “wort” and the insoluble materials, called “spent grains” to deactivate enzymes. Additional water may be sprinkled on the grains to extract additional sugars (a process known as sparging). Lautering is typically executed at a temperature of about 78° C.
“Wort boiling” involves heating of the wort at water boiling temperature. The key purposes of boiling is to (i) kill microorganisms in order to eliminate competition for the fermentation microorganisms, (ii) coagulate and to precipitate proteins or other solids that may cause turbidity of the beer, and (iii) extract and chemically modify bitter, aromatic and flavoring compounds from herbs or herb extracts added before or during wort boiling.
“Cooling and inoculation” involves the cooling of the boiled wort to a temperature that is optimal for the fermentation microorganisms. These fermentation microorganisms, for example brewer's yeast (Saccharomyces cerevisiae), are either added on purpose to the wort (called “pitching”) or added by spontaneous inoculation.
“Fermentation” involves the incubation of the wort inoculated with one or more fermentation microorganisms. During fermentation the simple sugars are converted by these microorganisms into carbon dioxide, ethanol and/or organic acids and numerous other by-products.
“Post-fermentation processing” refers to one or more optional steps following primary fermentation up to the production and packaging of a finished beer. Depending on the type of beer and the method used, such post-fermentation processing may involve one or more of the following: the beer may be conditioned to further develop desirable flavors and aromas and/or reduce the levels of undesirable flavors and aromas; the beer can be filtered to remove the residual yeast and other turbidity-causing materials; the beer can be treated with an absorbent to remove particular compounds such as hydrophilic proteins or polyphenols; the beer can be subjected to additional fermentation steps (with or without addition of an extra carbon dioxide source); herbs or herb extracts can be added; fruits or fruit extracts can be added; the beer can be carbonated to increase the bubbly aspect of beer; the beer can be pasteurized or microfiltrated to enhance microbial stability; and the beer can be packaged by e.g. bottling, canning or kegging.
   The term “real extract”, in the context of this invention, is defined as the grams of dry matter per 100 ml beer obtained after evaporation of the liquid and gaseous fraction (water, alcohol, dissolved gasses) of the beer.

In the context of the present invention the term “endoxylanase” refers to an enzyme that is able to hydrolyze glycosyl bonds linking xylose residues in xylose-containing polysaccharides. Endoxylanases can be derived from a variety of organisms, including plant, fungal (e.g. species of Aspergillus, Penicillium, Disporotrichum, Neurospora, Fusarium, Humicola, Trichoderma) or bacterial species (e.g. species of Bacillus, Aeromonas, Streptomyces, Nocardiopsis, Thermomyces). Commercially available purified or partially purified endoxylanase preparations suitable for the practice of this invention include, but are not limited to, Shearzyme™ (Novozymes), Biofeed Wheat™ (Novozymes), Pentopan™ Mono (Novozymes), Pulpzyme™ (Novozymes), Ecopulp™ (AB Enzymes), Veron™ 191 (AB Enzymes), Veron™ Special (AB Enzymes), Multifect™ Xylanase (Genencor/Danisco), Multifect™ 720 (Genencor/Danisco), Spezyme™ Cp (Genencor/Danisco), Grindamyl™ H640 (Danisco), and Grindamyl™ Powerbake™ (Danisco).

The term “non-inhibited endoxylanase” refers to an endoxylanase enzyme whose activity over 1 hour incubation is inhibited by less than 20% by the presence of a proteinaceous endoxylanase inhibitor present at concentrations typical in a regular cereal-based mash with an original gravity ranging from about 7 to 25 g/100 ml. A non-limiting example of a commercially available non-inhibited endoxylanase suitable for the practice of this invention is Grindamyl™ Powerbake™ (Danisco). Other examples of such less inhibited enzymes belonging to family 11 endoxylanases are disclosed in WO2001/066711.

The term “thermostable endoxylanase” refers to an enzyme whose activity at 72° C. over 1 hour incubation is reduced by less than 80% compared to the optimum temperature in conditions occurring in a cereal-based mash with an original gravity ranging from about 7 to 25 g/100 ml. A non-limiting example of a commercially available thermostable endoxylanase suitable for the practice of this invention is Ecopulp™ TX200A (AB Enzymes).

The term “thermostable non-inhibited endoxylanase” refers to an endoxylanase combining the properties of a non-inhibited endoxylanase and a thermostable endoxylanase. Examples of such thermostable non-inhibited endoxylanase family 11 endoxylanases are disclosed in WO2003/02923.

The term “mouthfeel” is used to depict the carbonation, fullness and after-feel of a beer where these descriptors are used to describe the textural attributes that are responsible for producing characteristic tactile sensations on the surface of the oral cavity.

The term “bran” in the context of the present invention, means a seed-derived milled fraction derived from cereal grains that is enriched in any or all of the tissues to be selected from aleurone, pericarp, seed coat, sepals, and petals, as compared to the corresponding intact seed.

Although the beers and beverages according to the present invention are most frequently produced from malted cereal grains, i.e. the brewing process usually includes an initial malting step of a type well known in the art, they can also be produced starting from unmalted cereal grains, preferably milled cereal grains, i.e. the brewing process may then start with the mashing step. The use of unmalted cereals then requires the addition of one or more exogenous enzymes during the initial mashing step in order to obtain sufficient fermentable substrate in the wort. In a specific embodiment, said one or more exogenous enzymes may be selected from the group consisting of β-amylase, γ-amylase, α-amylase (e.g. from B. subtilis, or a high-heat thermostable α-amylase from B. licheniformis), proteases (e.g. from B. subtilis), β-glucanase (e.g. from B. subtilis), α-L-arabinofuranosidase (e.g. from a Aspergillus strain such as Aspergillus niger), and mixtures thereof. When unmalted cereal grains are cooked to eliminate residual microorganisms on the grains prior to the mashing step, it is possible to inoculate the mash with yeast or another fermenting micro-organism prior to the lautering step, such that at least part of the fermentation process takes place in presence of the insoluble cereal material. After an incubation period, the at least partially fermented wort is then submitted to the lautering step. When an endoxylanase is added to the mash according to the present invention, this procedure has the particular advantage that the endoxylanase also acts on the water-unextractable arabinoxylans in the cereal material during the fermentation step and thus releases additional soluble arabinoxylans.

The present invention may, if necessary for the quality control of the production method, include the measurement and/or the analysis of the concentration of soluble AXOS in beer at one or more steps of the brewing process. Said method comprises the analytical techniques described in example 1 of the present invention.

The invention is further illustrated by way of the non-limiting illustrative embodiments described below.

### Comparative Example 1

### AXOS Content in Different Types of Commercial Beers

### Analytical Techniques.

Different analytical techniques have been used for the full characterisation of commercial beers.

Alcohol content of beer samples was measured by near infrared spectroscopy (Alcolyzer Plus, Anton Paar, Graz, Austria), apparent extract was measured based on solution density by an oscillating U-tube density meter (Alcolyzer Plus, Anton Paar), and real extract and original extract (original wort gravity) were calculated from the alcohol and density measurements, all according to standard methods outlined in Analytica EBC (1998).

Determination of total and reducing sugar content of beer was performed based on the method of Courtin et al. (2000) in Journal of Chromatography A, 866, 97-104. Beer samples were first decarbonated by sonication for 10 minutes followed by filtration through a standard paper membrane. For determination of AXOS and maltodextrin content, 2.5 ml beer was mixed with 2.5 ml 4.0 M trifluoroacetic acid (2.0 M final concentration) and incubated at 110° C. for 60 minutes. After the hydrolysis, the mixture was filtered and 3.0 ml of the filtrate was further treated by adding 1.0 ml of an internal standard solution (100 mg beta-D-allose in 100 ml of a 50% saturated benzoic acid solution), 1.0 ml of ammonia solution (25% v/v) and 3 drops of 2-octanol. The monosaccharides were reduced to alditols by addition of 200 μl of sodium borohydride solution (200 mg sodium borohydride in 1.0 ml 2 M ammonia) and the sample was incubated for 30 minutes at 40° C.. The reaction was stopped by addition of 400 μl of glacial acetic acid. For the acetylation reaction, 500 μl of the sample containing the alditols was added to 5.0 ml of acetic anhydride and 500 μl of 1-methyl-imidazole. After 10 minutes, the excess of acetic anhydride was removed by addition of 900 μl ethanol to the sample. Alditol acetates were then concentrated in the organic phase by addition of water (10 ml) and potassium hydroxide solution (2 times 5.0 ml of 7.5 M solution, with an intermediate rest of a few minutes). A bromophenol blue solution (500 μl , 0.04% w/v) was added as an indicator for the aqueous phase. Aliquots of 1 μl of the organic phase containing the formed alditol acetates were separated by gas chromatography on a Supelco SP-2380 polar column (30 m×0.32 m I.D.; 0.2 μm film thickness) (Supelco, Bellefonte, Pa., USA) in a chromatograph (Agilent 6890 series, Wilmington, Del., USA) equipped with an auto-sampler, a splitter injection port (split ratio 1:20) and a flame ionisation detector. The purified monosaccharides D-galactose, D-xylose, D-glucose and L-arabinose were treated in parallel with each set of samples for calibration purposes.

For the determination of the average DP of AXOS in beer, 2.5 ml of beer was treated by adding 500 μl of an internal standard (100 mg beta-D-allose in 100 ml of a 50% saturated benzoic acid solution), 50 μl ammonia solution (25% v/v) and 9 drops of 2-octanol. The saccharides were reduced to alditols by addition of 200 μl of sodium borohydride solution (200 mg sodium borohydride in 1.0 ml 2 M ammonia) and the sample was incubated for 30 minutes at 40° C. The reaction was stopped by the addition of 400 μl glacial acetic acid. An aliquot of 2.5 ml of the sample containing reduced saccharides was hydrolyzed by addition of 500 μl trifluoroacetic acid (99%) and the sample was incubated at 110° C. for 60 minutes. After hydrolysis, acetylation and gas chromatography analysis was performed as described above. The purified monosaccharides D-xylose, D-glucose and L-arabinose were treated in parallel with each set of samples for calibration purposes.

The content of AXOS (C-AXOS), also called hereafter the content of soluble arabinoxylans, of the beer samples was calculated using formula (1). The content of AXOS corrected for arabinogalactan content (AXOS_{cor}) was calculated according to formula (2). The arabinose to xylose ratio of AXOS (A/X AXOS) was calculated according to formula (3). The arabinose to xylose ratio of AXOS corrected for arabinogalactan content (A/X_{cor} AXOS) was calculated according to formula (4). The average degree of polymerisation (avDP) of AXOS (avDP AXOS), also called hereafter the average degree of polymerisation of soluble arabinoxylans, was calculated using formula (5). The average degree of polymerisation of the xylan backbone of AXOS (avDP Xylan) was calculated using formula (6). Maltodextrin concentration was calculated according to formula (7).

C-AXOS=0.88×(% arabinose+ % xylose) (1)

C-AXOS_{cor}=0.88×(% arabinose−0.7× % galactose+ % xylose) (2)

A/X AXOS= % arabinose/ % xylose. (3)

A/X_{cor} AXOS=(% arabinose−0.7× % galactose)/ % xylose. (4)

avDP AXOS=(% arabinose−0.7× % galactose+ % xylose)/ % reducing end xylose (5)

avDP Xylan= % xylose/ % reducing end xylose (6)

Maltodextrin=0.9×(% glucose) (7)

The subtraction of the % galactose in formulae (2), (4) and (5) is meant as a correction for the arabinogalactan content in beer or wort. It should be noted that, with formula (6), the avDP specifically applies to the beta-1,4-D-xylopyranosyl backbone of AXOS, and does not take into account the arabinose side chains.

A series of commercial beers was collected that represents widely different beer styles, including non-alcoholic beers, Pilsener style beers, American light beers, ales, sour ales, Belgian white beers, German Weizenbieren (wheat beers), blond strong ales (among which Belgian abbey tripels), dark strong ales, and gueuze Iambic beers. Each beer was analysed for alcohol content, real extract, original extract (original wort gravity), maltodextrin content, arabinoxylo-oligosaccharide (AXOS) content, and for the average arabinose to xylose ratio (A/X) and average degree of polymerisation (avDP) of AXOS according to the determination methods described above, and results are shown in table 1.

The AXOS content was lowest in the American light beers, which contained between 0.58 g/l (“Natural Light”) and 0.68 g/l (“Bud Light”) of AXOS. Highest AXOS contents were observed in the strong ales, ranging between 1.44 g/l (“Westmalle Tripel”) and 2.14 g/l (“Kasteelbier bruin”). Generally, there is a good correlation between AXOS content and original extract, which is not surprising as higher gravity worts will result in more solubilisation of carbohydrates, including arabinoxylans.

The average degree of polymerisation of AXOS (avDP AXOS) in beers ranged from 8 in the blond strong ale “Tripel Karmeliet” to 25 in the German Weizenbier “Paulaner Hefe-Weissbier”. No known correlation exists between the average degree of polymerisation of AXOS and the real or original extract levels in beers. The low average degree of polymerisation found may indicate that endogenous endoxylanases from the cereals are either active during malting, and/or during mashing. The average A/X ratio of AXOS fluctuates between a relatively narrow range from 0.66 to 0.80 (between 0.55 to 0.67 after correction for arabinogalactan).

### Example 2

### Increase of Soluble AXOS in Beer by use of Endoxylanase Enzymes

Materials. Grindamyl® H640 is a commercial food-grade endoxylanase preparation from Danisco (Copenhagen, Denmark) produced through expression in Bacillus subtilis of a Bacillus subtilis glycoside hydrolase family (GHF) 11 endoxylanase gene. Grindamyl® H190 is a commercial food-grade endoxylanase preparation from Danisco (Copenhagen, Denmark) produced from Aspergilus niger. Grindamyl® Powerbake® is a commercial food-grade endoxylanase preparation from Danisco (Copenhagen, Denmark) produced through expression in Bacillus subtilis of a non-inhibited mutant of a Bacillus subtilis GHF 11 endoxylanase gene. Ecopulp® TX200A (ECOP) is a commercial technical grade endoxylanase preparation from AB Enzymes (Darmstadt, Germany) produced through recombinant expression of a thermophilic mutant of a Trichoderma longibrachiatum GHF11 endoxylanase gene. Shearzyme® 500L is a commercial food-grade endoxylanase preparation from Novozymes (Bagsvaerd, Denmark) prepared by recombinant expression in Aspergillus oryzae of an Aspergillus aculeatus GHF10 endoxylanase gene. The wheat endoxylanase inhibitor TAXII was purified as described in the literature (Gebruers et al. (2001) in Biochem. J. 353:239-244). Barley malt and wheat were obtained from Cargill (Herent, Belgium), wheat bran was obtained from Dossche Mills & Bakery (Deinze, Belgium), and rye bran was obtained from Molens Goethals (Ghent, Belgium).

Analytical methods. For the calculation of the soluble AXOS content in the different wort or beer preparations run in parallel experiments, the data were standardised for efficiency of carbohydrate extraction using a factor consisting of the average mannose concentration in all experimental samples tested in parallel divided by the mannose concentration of each individual experimental sample.

Determination of the activity of the xylanolytic enzymes. The endoxylanase activity of the enzymes was measured colorimetrically using azurine-crosslinked arabinoxylan (Xylazyme AX tablets, Megazyme, Bray, Ireland) as an insoluble substrate as described in Megazyme Data Sheet 9/95, using a 25 mM sodium acetate (pH 4.7) as a buffer and an incubation for 10 minutes at 40° C. One unit was defined as the amount of enzyme required to yield a change in extinction at 590 nm of 1.0 under the assay conditions.

In a first experiment, different types of endoxylanase enzymes, substrates, and incubation conditions were tested to find conditions that lead to elevation of soluble AXOS levels in wort during the mashing process. When soluble AXOS are produced during mashing they will end up in the final beer product because soluble AXOS are very heat stable, so they will not be destroyed during boiling, and because they can not be used as a carbon source by Saccharomyces cerevisiaea given that this organism does not even contain endoxylanase- or arabinofuranosidase-encoding genes. Grindamyl Powerbake, a glycoside hydrolase family 11 endoxylanase from Bacillus subtilus is engineered to reduce inhibition of endoxylanase activity by endoxylanase inhibitors from cereals such as TAXI and related proteins. The mash consisted of Pilsener-type barley malt at 200 g/l, and another one consisting of a mix of Pilsener-type barley malt at 140 g/l and wheat bran at 60 g/l. The mashes were suspended in water at 45° C. and the enzymes were added at the start of the process. The mashes were first incubated at 45° C. during either 90 minutes or 150 minutes, then heated to 70° C. at 1° C. per minute, and kept at 70° C. during 60 minutes. Following lautering by filtration, the wort was boiled during 60 minutes. After cooling, the worts were frozen at −20° C. until analysis of the carbohydrates. Before carbohydrate analysis, the worts were centrifuged (10,000 g, 15 minutes, 18° C.) to remove particulate material.

As shown in Table 2, the non-inhibited enzyme Grindamyl Powerbake added at enzyme activities of 20 Units/l or 100 Units/l did cause a significant raise in soluble AXOS levels. At a dose of 100 Units/l and an incubation time of 150 min, Grindamyl Powerbake increased the soluble AXOS content in the barley malt mash by 47% relative to the basic treatment without enzyme addition.

In a second experiment, the effect of addition of different types of endoxylanases was analysed on the release of soluble AXOS in wort prepared from Pilsener-type barley malt suspended at 200 g/l in the mash. The temperature regime was 120 minutes at 45° C., 30 minutes at 60° C., and 60 minutes at 72° C.. The different enzymes tested were Grindamyl H640, a GHF 11-endoxylanase from Bacillus subtilis that is inhibited by endoxylanase inhibitors from cereals; Grindamyl H190, a GHF 11-endoxylanase from Aspergillus niger that is inhibited by endoxylanase inhibitors from cereals; Grindamyl Powerbake, a GHF 11 endoxylanase from Bacillus subtilus is engineered to reduce inhibition of endoxylanase activity by endoxylanase inhibitors from cereals; Shearzyme 500 L, a GHF 10-endoxylanase from Aspergillus aculeatus whose activity is not inhibited by cereal endoxylanase inhibitors.

At equal endoxylanase activities (250 Units/l), Grindamyl Powerbake released substantially more soluble AXOS than Grindamyl H640 or Grindamyl H190, demonstrating that non-inhibited endoxylanases are more efficient over inhibited endoxylanases for release of soluble AXOS in beer (Table 3). Also, Grindamyl Powerbake released more soluble AXOS than Shearzyme 500L at equal enzyme activities (250 Units/l), indicating that glycoside hydrolase family 11-endoxylanases perform better than glycoside hydrolase family 10-endoxylanases with respect to solubilisation of AXOS in wort. Shearzyme 500L, on the other hand, caused the highest reduction of the avDP of soluble AXOS, reducing the avDP in the wort from 13 to 6, whereas Grindamyl H640 and Grindamyl Powerbake had little or no effect on this parameter. This is consistent with the notion that the catalytic properties of glycoside hydrolase family 11 endoxylanases favour the release of soluble AXOS from insoluble arabinoxylan substrate, while glycoside hydrolase family 10 endoxylanases preferentially cleave soluble AXOS.

In the previous experiments the mashing temperature was kept relatively low (45° C.). For most beer types it is desired to use a higher mashing-in temperature, as this reduces oxidation reactions and avoids undesired off-taste and taste instability. In a third experiment, the effect was tested of addition of Ecopulp TX200A, a GHF 11 endoxylanase from Trichoderma longibrachiatum (formerly Trichoderma reesei) that is engineered for increased thermostability. The temperature regime was 30 minutes at 60° C., 60 minutes at 72 ° C., and 120 minutes at 78° C..

At doses of 2,500 endoxylanase Units/I and 5,000 endoxylanase Units/I, Ecopulp TX200A increased the level of soluble AXOS by 129% (about 2.3-fold) and 140% (about 2.4-fold), respectively, relative to the level in the control brew without enzyme addition (Table 4). Soluble AXOS levels in wort of up to 3.7 g/l were obtained upon addition of Ecopulp TX200A. The combination of Ecopulp TX200A and Shearzyme 500L resulted in high solubilisation of AXOS as well as to reduction of the avDP of AXOS to 8, down from 16 in the corresponding control wort. It follows from these experiments that a thermostable enzyme is preferred for enriching soluble AXOS in beer when working at high mashing-in temperatures.

Inhibition of the endoxylanase activity of Ecopulp TX200A by the wheat endoxylanase inhibitor TAXI I was assessed as follows. Two endoxylanase units of Ecopulp TX200A were pre-incubated in 0.5 ml sodium phosphate buffer (25 mM, pH 6.0) in either absence or presence of 65 μg purified TAXI I at room temperature for 30 minutes. Thereafter, the endoxylanase activities of the solutions were determined at 70° C. by the colorimetric method using Xylazyme (Megazyme, Bray, Ireland) as substrate according to the manufacturers instructions. The activity of the mixture of Ecopulp TX200A and TAXI I was 104% relative to that of Ecopulp TX200A in absence of TAXI. It can therefore be concluded that Ecopulp TX200A is not significantly inhibited by the presence of cereal endoxylanase inhibitors such as TAXI at its optimum temperature of 70° C., which contributes to the high efficiency of this enzyme for the solubilisation of AXOS during the mashing process.

In a fourth experiment, the effect was tested of the addition of Ecopulp TX200A, a thermostable non-inhibited glycoside hydrolase family 11-endoxylanase from Trichoderma longibrachiatum (formerly Trichoderma reesei), to three different grists: a first one consisting of 100% Pilsener-type barley malt at 200 g/l, a second one consisting of a mix of 90% Pilsener-type barley malt at 180 g/l and 10% wheat bran at 20 g/l, and a third one consisting of a mix of 90% Pilsener-type barley malt at 180 g/l and 10% rye bran at 20 g/l. The temperature regime was 60 min at 62° C., 30 minutes at 72° C., and 60 minutes at 78° C. and the Ecopulp TX200A endoxylanase enzyme was added at a dose of 4,000 Units/I.

As shown in Table 5, addition of Ecopulp TX200A endoxylanase raised the soluble AXOS content from 1.6 g/l to 2.2 g/l in the wort made on the basis of 100% Pilsener barley malt, from 1.7 g/l to 4.0 g/l in the malt/wheat bran mix, and from 2.0 to 3.6 g/l in the malt/rye bran mix, respectively.

Two beers were prepared on pilot scale according to the following method. The mash for beer A was prepared by mixing 10 kg Pilsener malt with 50 liter of brewing water. The mash for beer B was prepared by mixing 9 kg Pilsener malt, 1 kg rye bran, and 10 ml Ecopulp TX200A (15000 Units/ml; AB Enzymes), and 5 ml Shearzyme 500L (2500 Units/ml; Novozymes) with 50 liter water. Brewing water consisted of water purified by reverse osmosis to which Ca²⁺ was added to a final concentration of 40 mg/l. The mashing temperature scheme was as follows: 63° C. (45 minutes), 72° C. (45 minutes), 78° C. (1 minute). The pH of the mash was 5.6. The alpha-amylase enzyme preparation Termamyl (Termamyl 120 L, from Novozymes) was added to both brews at 7.5 ml per brewing mash when the temperature had reached 78° C.. Lautering was performed over a lauter tun at a temperature of 78° C. during 60 minutes. The filtered worts were boiled during 60 minutes and Zn²⁺ was added to a final concentration of 0.2 mg/l at 5 minutes before the end of boiling. The boiled worts were clarified using a whirlpool. One part of the clarified worts were diluted 1:1 (v:v) with oxygen-free water in order to make light lager beers A and B respectively. The other part of the clarified worts were left undiluted and were used to make regular Pilsener style lager beers. Cooled clarified worts were pitched with lager yeast (Saflager 3470, from Lesaffre) at 10⁷ cells/ml, followed by fermentation during 8 days at 12° C. and lagering during 7 days at 0° C. The bitterness of the diluted beers was adjusted by addition of isomerised hop acid extract (20% iso—acids w/v, Botanix Ltd., Paddock Wood, England) at a final concentration of 25 mg/l iso—acids. The beers were filtered over kieselguhr/cellulose sheets (1 μm) and finally bottled and sealed in brown standard 25 cl bottles (O₂-content<80 ppb) using an isobaric filling machine with double pre-evacuation (America monobloc, from Cimec, Italy).

The soluble AXOS level of beer B was 3.53 g/l versus 0.95 g/l for control beer A (Table 6). Hence, the combination of the replacement of 10% of the malt by rye bran and the addition of arabinoxylan-solubilising endoxylanases during the mashing process resulted in a 3.7-fold increase (i.e. increased by 272%) in AXOS content. The soluble AXOS content of the worts was similar to that of the corresponding beers, indicating that measuring soluble AXOS content in the wort is highly predictive for the soluble AXOS content in the final beer. The soluble AXOS content of beer B was even slightly higher than that of wort B, which is explained by concentration of the beer due to evaporation occurring mainly during wort boiling. The level of soluble AXOS in the light beer B was 1.93 g/l versus 0.88 g/l for the control light beer A, thus leading to an increase by about 2.2 fold (i.e. increase by 119%) in AXOS content versus the control light beer. Increasing the soluble AXOS contents of worts clearly does not inhibit the fermentation process, as indicated by the observation that the alcohol content of beer B and light beer B was not lower than that of control beer A and control light beer A, respectively (Table 6).

The person skilled in the art understands that other improved thermostable and non-inhibited enzymes than Ecopulp TX200A can be used in the experiments described above. Methods that can be used for enzyme improvement include for instance directed evolution methods to increase the thermostability of endoxylanases by making a library of enzyme variants through a combination of gene site saturation mutagenesis and gene reassembly technology, followed by screening for xylanolytic activity at high temperature. Improvement of the enzymes can also be realised by rational site directed engineering to introduce selected codon substitutions leading to an enzyme with improved catalytic activity at high temperatures. Alternatively, orthologous genes of the currently used bacterial or fungal endoxylanase enzyme genes can be isolated from related thermophilic or hyperthermophilic microorganisms and used for the production of thermostable enzymes through expression in a heterologous host organism.

Other enzymes than endoxylanases can be used together with endoxylanases to further increase the release of AXOS during mashing or other steps in beer production, such as for instance arabinofuranohydrolases, feruloyl esterases, methyl glucuronidases, beta-glucanases or cellulases. Such enzymes remove either side chains of arabinoxylan or degrade other substrates that are entangled with arabinoxylans, and thus facilitate the accessibility of the arabinoxylans to endoxylanases.

The person skilled in the art will also understand that the endoxylanases can be used in combination with enzymes, such as amyloglucosidases and/or pullulanases, that are added with the aim to reduce the content of fermentable sugars in the final beer. Amyloglucosidases, pullulanases or other so-called attenuation enzymes are typically used for the production of light beers and/or low carbohydrate beers, which have an attenuated level of residual fermentable maltodextrins. Hence, the combined use of endoxylanases and attenuation enzymes, added during mashing or other steps in beer production, can be used to produce light beers with an increased AXOS content.

### Example 3

### Increase of Soluble AXOS in Beer by Addition of AXOS-Rich Preparations After Fermentation

Preparation of AXOS from bran (AXOS-18-0.31). Commercial wheat bran (Dossche from Mills & Bakery, Deinze, Belgium) was used as starting material for the preparation of AXOS-18-0.31. A suspension of wheat bran in water (1:7 w/v) was first treated with a thermostable α-amylase (Termamyl 120LS, from Novozymes, Bagsvaerd, Denmark; 1 μl/g wheat bran) for 90 minutes at 90° C. to hydrolyse the starch. After cooling to 50° C., the pH of the suspension was adjusted to 6.0 using concentrated HCl and the suspension was incubated with a protease (Neutrase 0.8L, commercially available from Novozymes, Bagsvaerd, Denmark; 40 μl/g wheat bran) for 4 hours at 50° C. to hydrolyse residual proteins. Thereafter, the suspension was boiled during 20 minutes, filtered and the filtrate discarded. The residue was washed with water, and re-suspended in deionised water (1:14 w/v). The suspension was incubated under continuous stirring for 10 hours at 50° C. with the endoxylanase Grindamyl H640 (Danisco, Copenhagen, Denmark) at 1.4 units per g de-starched and de-proteinised wheat bran, and for another 10 hours at 50° C. after addition of a second dose of Grindamyl H640 at 1.1 units per g de-starched and de-proteinised wheat bran. After inactivation of the enzyme by boiling (30 minutes), the solution was concentrated till 20% dry matter in a falling film evaporator and dried in a spray-drier. The spray-dried material was dissolved in water (1:25 w/v) and treated with active carbon to remove possible off-flavours resulting from the production process. The suspension of AXOS and active carbon (0.75 g/g AXOS) was stirred for 1 hour at 18° C.. After decantation, the active carbon was removed by centrifugation (10,000 g, 30 minutes, 18° C.), and the supernatant was lyophilized. The preparation had a soluble AXOS content (expressed as % arabinoxylan of dry matter) of 78.8%, the soluble AXOS has an arabinose to xylose ratio of 0.31, and an avDP of 18.

Preparations of soluble AXOS-containing beers. A commercial light beer (Bud light, brewed by Anheuser-Bush, St Louis, USA) was used as a basis to prepare soluble AXOS-containing beers. A beer containing 2 g/l of pure AXOS-18-0.31 was made by dissolving 25.4 g/l AXOS-18-0.31 (78.8% purity) in beer through stirring, and then diluting the solution 1:10 (v/v) in beer. A beer containing 10 g/l of pure AXOS-18-0.31 was made by dissolving 127 g/l AXOS-18-0.31 (78.8% purity) in beer through stirring, and then diluting the solution 1:10 (v/v) in beer. The corresponding control beer was made by diluting stirred beer 1:10 in beer.

Sensory analyses. Sensory analyses were conducted in a quiet room in sessions involving maximally 10 volunteers at once. The subjects were first familiarised with the procedures and subsequently asked to taste coded beer samples with different concentrations of soluble AXOS. During tasting the subjects wore light-tight eye masks and they were helped individually by an assistant that handed over the samples and recorded the responses. The order by which the samples were presented was random. The subjects were asked to make a ranking of the samples in order or increasing mouthfeel. Data were analysed statistically by Friedman's rank sum test using the Analyse-it software, version 1.71.

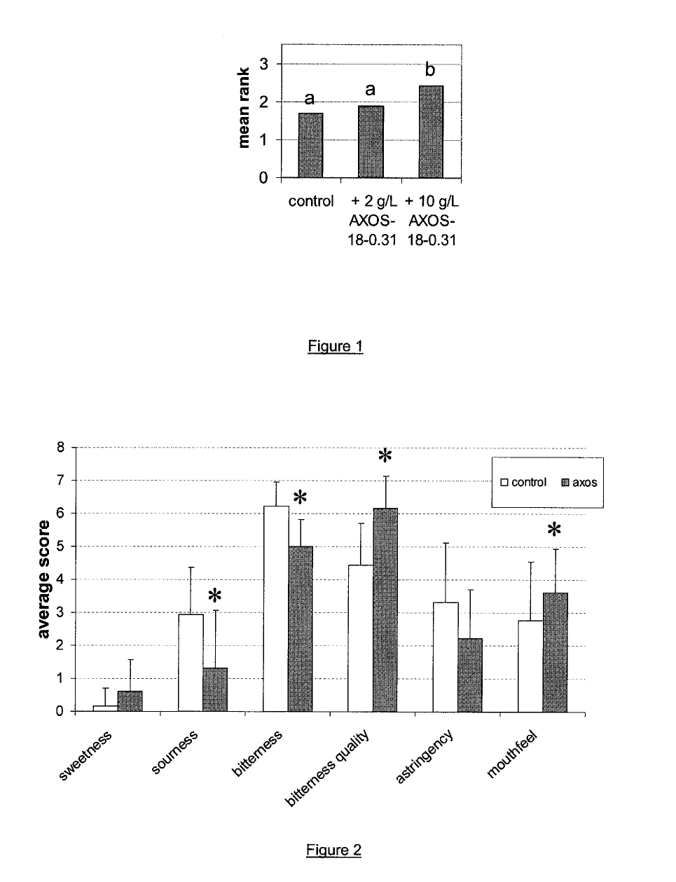

A commercial light beer (Bud light, brewed by Anheuser-Bush, St Louis, USA) was supplemented at either 2 g/l or 10 g/l with a soluble AXOS-rich preparation, called AXOS-18-0.31, that was isolated from wheat bran using a procedure involving endoxylanases. Sensory analysis was performed to determine the effect of AXOS addition on mouthfeel of the light beer. As shown in FIG. 1, addition of AXOS-18-0.31 improved mouthfeel of light beer both at 2 g/l and 10 g/l, and the difference from the control beer was significant at the 10 g/l rate.

It is concluded from this experiment that AXOS produced externally from an arabinoxylan-rich source, can be added to beer and that addition of AXOS to beer improves the mouth feel of beer. None of the beers supplemented with AXOS showed a notable increase in viscosity.

The person skilled in the art will understand that a soluble AXOS-enriched preparation can be added at different steps in the beer making process, including without limitation mashing, wort boiling, wort cooling, wort fermentation, beer conditioning, or beer finishing.

### Example 4

### Increase of Soluble AXOS in Beer by Addition of Soluble AXOS-Rich Preparations Before Fermentation

Preparation of AXOS from a Sidestream of Starch/Gluten Separation (AXOS-5-0.5).

Wheat Pentosan Concentrate (WPC, available from Pfeifer & Langen, Dormagen, Germany) is derived from a side stream of wheat flour processing into starch and gluten and its chemical composition has been described by Courtin and Delcour (1998) in J. Agric. Food Chem. 46:4066-4073. WPC is rich in water extractable arabinoxylan (ca. 43%) and protein material (ca. 30%). The remaining part mainly consists of arabinogalactan peptide (ca. 14%) and to a lesser extent, polymeric glucose (6%). The arabinoxylan in WPC has an arabinose to xylose ratio of 0.58, and an avDP of 58. WPC was solubilised in de-ionised water (1:10 w/v) and silica was added as an aqueous suspension (20% w/v) until a silica/protein ration of 7:1. The pH of the mixture was adjusted to 4.8 using 0.1 M HCl in order to obtain a maximal adsorption of the proteins to the silica. After 30 minutes stirring the suspension was Büchner filtered. The residue comprising the silica/protein was discarded, while the filtrate was further incubated at 30° C. during 24 hours with Shearzyme 500L (from Novozymes, Bagsvaerd, Denmark) at 29 units per g WPC. After inactivation of the enzyme by boiling (30 minutes), the obtained solution was cooled and subjected to an ethanol precipitation. Ethanol (95% v/v) was added under continuous stirring to a final concentration of 80% (v/v) and after stirring for an additional 30 minutes, settling (24 hours, 4° C.) and filtration, the obtained residue was dissolved in de-ionised water and again subjected to an ethanol precipitation. Ethanol (95% v/v) was added under continuous stirring to a final concentration of 65% (v/v) and after stirring for an additional 30 minutes, settling (24 hours, 4° C.) and filtration, the precipitated material was removed. The remaining supernatant was subjected to rotary evaporation, to remove ethanol, dissolved in de-ionised water and lyophilised. The obtained material was homogenised and sieved through a 250 μm sieve. The preparation had an AXOS content (expressed as % arabinoxylan of dry matter) of 78.5%, an arabinose to xylose ratio of 0.5, and an avDP of 5.

Preparations of Soluble AXOS-Containing Beers.

Experimental beers were prepared on pilot scale as follows. Mashing was performed by mixing 33.33 kg Pilsner malt (coarse milling by two-roller mill), 2.83 kg glucose and 120 I brewing water (reverse osmosis with addition of Ca2+ to a final concentration of 40 mg/l). The mashing temperature scheme was as follows: 63° C. (35 minutes), 72° C. (20 minutes), 78° C. (1 minute). The pH of the mash was controlled at pH 5.2 by addition of lactic acid. Lautering was performed over a lauter tun at a temperature of 78° C. during 90 minutes. The filtered wort was divided over two fractions: a first fractions of 10 l (control beer) and a second fraction of 10 l (soluble AXOS-enriched beer). The two wort fractions were boiled separately during 60 minutes. The worts were hopped by addition of isomerised hop acid extract (20% iso-alpha-acids w/v, from Botanix ltd., Paddock Wood, England) to a final concentration of 25 mg/l iso-alpha-acids at 5 minutes before the end of boiling. Zn2+ was added to a final concentration of 0.2 mg/l at 5 minutes before the end of boiling. At 5 min before the end of boiling, 76.4 g of AXOS-5-0.5 was added to the second 10 l fraction of wort to produce AXOS-enriched beer. Prior to addition, AXOS-5-0.5 was dissolved at 1:10 (w/v) in water, and stirred during 30 minutes.

The boiled worts were clarified using a whirlpool. The clarified worts were diluted 1:1 (v:v) with oxygen-free water.

Cooled clarified worts were pitched with lager yeast (Saflager 3470, Lesaffre) at 10⁷ cells/ml, followed by fermentation during 8 days at 12° C. and lagering during 7 days at 0° C.

The bitterness of the diluted beers was adjusted by addition of isomerised hop acid extract (20% iso-alpha-acids w/v, Botanix ltd., Paddock Wood, England) at a final concentration of 25 mg/l iso-alpha-acids. The beers were filtered over kieselguhr/cellulose sheets (1 μm). The beers were bottled and sealed in brown standard 25 cl bottles (02 content <80 ppb) using an isobaric filling machine with double pre-evacuation (America monobloc, Cimec, Italy).

Sensory analyses. Sensory analyses were conducted in a quiet room by a trained panel. The order by which the samples were presented was random. The sensory properties sweetness, sourness, bitterness, astringency and mouthfeel (fullness) were given a score on a scale from 0 (not detectable) to 8 (very strong). The sensory property bitterness quality was given a score from 0 (very unpleasant) to 8 (very pleasant). The scores were analyzed statistically by paired t-tests using an Analyse-it software, version 1.73. The panellists were also asked to indicate the preference for one of the two beers. The preference data were analysed statistically by the McNemar's change test using the Analyse-it software, version 1.73.

Two experimental light, low-alcohol beers were prepared on pilot scale starting from the same wort, one with and one without AXOS addition. An AXOS preparation having an average DP of 5 and an A/X ratio of 0.5, called AXOS-5-0.5, that was isolated from a side-stream of industrial wheat processing (see materials and methods), was added to one of the two brews at the end of the wort boiling step. The properties of the two beers are shown in Table 7. Both beers had very similar alcohol contents (about 2.7% v/v), similar real extracts (about 2.3 g/100 ml), and original extracts (about 6.7 g/100 ml), yet the maltodextrin contents of the AXOS-enriched beer was slightly lower while its content in AXOS was about 2.5-fold higher (increased by 151%) than that of the control beer (2.78 g/l versus 1.09 g/l for AXOS-enriched and control beer, respectively).

Sensory analysis was performed to determine the effect of addition of this AXOS preparation on beer taste and mouthfeel (FIG. 2). Addition of AXOS-5-0.5 to the beer resulted in a significantly (p<0.05) decreased sourness and bitterness sensation, while the quality of the bitterness as well as the mouthfeel was significantly improved. Out of the 13 panellists, 12 preferred the AXOS-enriched beer over the control beer (exact p value=0.0034 according to McNemar test). These data again clearly indicate that AXOS does have a positive impact on beer taste and mouthfeel.

### Example 5

### Increase of Soluble AXOS in a Beer Comprising About 7% Alcohol and 5.8 g/100 ml Real Extract

Another soluble AXOS-enriched strong beer is prepared as follows: grist: finely milled Pilsner malt (28 kg), an AXOS-rich preparation from wheat bran called AXOS-18-0.31 (see materials and methods of example 3) (6 g/l); brewing water: reverse osmosis (100 l) with addition of Ca²⁺ (40 mg/l); brewing scheme: 63° C. (30 minutes), 72° C. (45 minutes), 78° C. (120 minutes, including wort filtration with lauter tun); pH of the mash controlled at pH 5.6; wort boiling: 75 minutes; wort clarification: whirlpool; addition of Zn²⁺ (0.2 mg/l) to clarified wort; hopping: addition of isomerised hop acid extract (20% iso-α-acids w/v, Botanix ltd., Paddock Wood, England) at end of wort boiling; yeast pitching rate: 5×10⁶ top fermentation yeast cells/ml; fermentation: 9 days at 22-25° C.; maturation: in cask (10 days at 2° C.); beer filtration: kieselguhr/cellulose sheets (1 μm). The AXOS-enriched strong ale has an alcohol percentage of about 7%, a real extract of about 5.8 g/100 ml and an AXOS content of about 5 g/l.

TABLE 1
Analysis of different commercial beers.

| | | | | | | Real |
|---|---|---|---|---|---|---|
| | | | | Fermentation | Alcohol | extract |
| Beer brand | Brewery | Country | Beer style | type | (% v/v) | (g/100 ml) |
| Jupiler N.A. ® | Interbrew Belgium | Belgium | Non-alcoholic | Bottom | 0.52 | 6.25 |
| Tourtel Malt ® | Alken-Maes | Belgium | Non-alcoholic | Bottom | 0.31 | 5.72 |
| Bud Light ® | Anheuser-Busch | USA | American Light | Bottom | 4.11 | 2.28 |
| Coors Light ® | Coors Brewing Co. | USA | American Light | Bottom | 4.15 | 1.53 |
| Miller Lite ® | Miller Brewing Co. | USA | American Light | Bottom | 4.04 | 1.19 |
| Natural Light ® | Anheuser-Busch | USA | American Light | Bottom | 4.08 | 1.29 |
| Budweiser ® | Anheuser-Busch | USA | Pilsner | Bottom | 4.89 | 3.5 |
| Busch Beer ® | Anheuser-Busch | USA | Pilsner | Bottom | 4.58 | 3.25 |
| Carlsberg Beer ® | Carlsberg Breweries | Denmark | Pilsner | Bottom | 5.50 | 4.12 |
| Coors ® | Coors Brewing Co. | USA | Pilsner | Bottom | 4.92 | 3.72 |
| Jupiler ® | Interbrew Belgium | Belgium | Pilsner | Bottom | 5.21 | 3.84 |
| Maes ® | Alken-Maes | Belgium | Pilsner | Bottom | 4.88 | 3.38 |
| Miller High Life ® | Miller Brewing Co. | USA | Pilsner | Bottom | 4.57 | 3.83 |
| Stella Artois ® | Interbrew Belgium | Belgium | Pilsner | Bottom | 5.16 | 3.9 |
| Duvel ® | Moortgat | Belgium | Blond Strong Ale | Bottom | 8.59 | 3.97 |
| Palm ® | Palm | Belgium | Ale | Top | 5.48 | 4.61 |
| Rodenbach ® | Rodenbach (Palm) | Belgium | Flemish Sour Ale | Top | 5.30 | 4.55 |
| Brugs WitBier ® | Alken-Maes | Belgium | Belgian Witbier | Top | 4.52 | 4.76 |
| Hoegaarden ® | Hoegaarden | Belgium | Belgian Witbier | Top | 4.92 | 4.55 |
| Erdinger Weissbier ® | Erdinger Weissbräu | Germany | German Weizenbeer | Top | 5.5 | 4.57 |
| Paulaner Hefe-Weissbier ® | Paulaner Brauerei | Germany | German Weizenbeer | Top | 5.31 | 4.48 |
| Gordon Finest Platinum ® | Anthony Martin | Belgium | Blond Strong Ale | Top | 11.99 | 3.21 |
| Leffe Blond ® | Interbrew Belgium | Belgium | Blond Strong Ale | Top | 6.61 | 5.8 |
| Tripel Karmeliet ® | Bosteels | Belgium | Blond Strong Ale | Top | 7.52 | 6.4 |
| Westmalle Tripel ® | Abdij Westmalle | Belgium | Blond Strong Ale | Top | 9.58 | 5.96 |
| Kasteelbier Bruin ® | Van Honsebrouck | Belgium | Dark Strong Ale | Top | 11.61 | 8.77 |
| Leffe Bruin ® | Interbrew Belgium | Belgium | Dark Strong Ale | Top | 6.56 | 5.64 |
| Gueuze Cuvée Réne ® | Lindemans | Belgium | Lambic-Gueuze | Spontaneous | 6.91 | 2.77 |

| | Original | Malto- | | | | | | |
|---|---|---|---|---|---|---|---|---|
| | gravity | dextrin | C-AXOS | C-AXOS_{cor} | | | | avDP |
| Beer brand | (g/100 ml) | (g/l) | (g/l) | (g/l) | A/X AXOS | A/X_{cor} AXOS | avDP AXOS | Xylan |
| Jupiler N.A. ® | 7.08 | 35.38 | 0.59 | 0.55 | 0.78 | 0.64 | 11 | 7 |
| Tourtel Malt ® | 6.21 | 41.03 | 0.80 | 0.74 | 0.74 | 0.61 | 17 | 11 |
| Bud Light ® | 8.94 | 12.57 | 0.68 | 0.63 | 0.68 | 0.56 | 9 | 6 |
| Coors Light ® | 8.26 | 5.87 | 0.58 | 0.54 | 0.69 | 0.58 | 12 | 8 |
| Miller Lite ® | 7.74 | 4.89 | 0.59 | 0.55 | 0.66 | 0.55 | 12 | 8 |
| Natural | 7.9 | 4.74 | 0.58 | 0.53 | 0.68 | 0.55 | 12 | 8 |
| Light ® | | | | | | | | |
| Budweiser ® | 11.41 | 20.71 | 0.85 | 0.79 | 0.68 | 0.57 | 10 | 6 |
| Busch Beer ® | 10.65 | 20.00 | 0.82 | 0.76 | 0.68 | 0.56 | 11 | 7 |
| Carlsberg | 13 | 23.04 | 1.54 | 1.47 | 0.71 | 0.63 | 11 | 7 |
| Beer ® | | | | | | | | |
| Coors ® | 11.67 | 19.66 | 0.77 | 0.72 | 0.70 | 0.59 | 12 | 8 |
| Jupiler ® | 12.26 | 22.22 | 1.27 | 1.20 | 0.76 | 0.66 | 13 | 8 |
| Maes ® | 11.26 | 20.60 | 0.92 | 0.86 | 0.74 | 0.63 | 16 | 10 |
| Miller High | 11.21 | 25.19 | 0.74 | 0.70 | 0.68 | 0.58 | 11 | 7 |
| Life ® | | | | | | | | |
| Stella Artois ® | 12.24 | 22.99 | 1.15 | 1.07 | 0.78 | 0.66 | 13 | 8 |
| Duvel ® | 17.81 | 20.82 | 1.37 | 1.29 | 0.72 | 0.61 | 9 | 5 |
| Palm ® | 13.45 | 29.43 | 0.92 | 0.85 | 0.75 | 0.60 | 17 | 11 |
| Rodenbach ® | 13.11 | 21.50 | 1.12 | 1.05 | 0.69 | 0.58 | 15 | 10 |
| Brugs | 12.06 | 29.89 | 0.93 | 0.77 | 0.84 | 0.52 | 17 | 11 |
| WitBier ® | | | | | | | | |
| Hoegaarden ® | 12.48 | 28.22 | 1.33 | 1.15 | 0.75 | 0.52 | 12 | 8 |
| Erdinger | 13.44 | 26.01 | 1.86 | 1.72 | 0.71 | 0.58 | 20 | 16 |
| Weissbier ® | | | | | | | | |
| Paulaner Hefe- | 13.05 | 25.29 | 2.00 | 1.84 | 0.66 | 0.53 | 25 | 17 |
| Weissbier ® | | | | | | | | |
| Gordon Finest | 22.47 | 9.84 | 1.85 | 1.73 | 0.72 | 0.62 | 12 | 8 |
| Platinum ® | | | | | | | | |
| Leffe Blond ® | 16.43 | 33.85 | 1.51 | 1.40 | 0.75 | 0.63 | 13 | 8 |
| Tripel | 18.48 | 33.96 | 1.84 | 1.69 | 0.71 | 0.57 | 8 | 5 |
| Karmeliet ® | | | | | | | | |
| Westmalle | 21.33 | 30.67 | 1.44 | 1.33 | 0.71 | 0.58 | 21 | 14 |
| Tripel ® | | | | | | | | |
| Kasteelbier | 27.28 | 36.49 | 2.14 | 2.03 | 0.76 | 0.67 | 10 | 6 |
| Bruin ® | | | | | | | | |
| Leffe Bruin ® | 16.2 | 33.66 | 1.48 | 1.38 | 0.76 | 0.63 | 14 | 9 |
| Gueuze Cuvée | 13.92 | 5.60 | 1.71 | 1.59 | 0.80 | 0.66 | 23 | 14 |
| Réne ® | | | | | | | | |

C-AXOS: content of AXOS expressed as g/l;
AXOS_{cor}: content of AXOS corrected for arabinogalactan, expressed as g/l;
A/X AXOS: arabinose to xylose ratio of AXOS;
A/X_{cor} AXOS: arabinose to xylose ratio of AXOS, corrected for arabinogalactan;
avDP AXOS: average degree of polymerisation of AXOS;
avDP Xylan: average degree of polymerisation of the xylan backbone of AXOS.

TABLE 2
Analysis of barley malt worts produced in presence of different concentrations of the non-inhibited endoxylanase
preparation Grindamyl Powerbake from Bacillus subtilis.

| | Enzyme | | | | C- | | | | |
|---|---|---|---|---|---|---|---|---|---|
| | dose | Incubation | C-AXOS | % increase | AXOS_{cor} | A/X | A/X_{cor} | avDP | avDP |
| Enzyme | (Units/l) | time at 45° C. | (g/l) | in C-AXOS | (g/l) | AXOS | AXOS | AXOS | Xylan |
| None | 0 | 30 min | 1.87 | 0% | 1.75 | 0.72 | 0.61 | 14 | 9 |
| None | 0 | 90 min | 2.01 | 7% | 1.87 | 0.72 | 0.60 | 15 | 10 |
| Grindamyl Powerbake | 20 | 90 min | 2.16 | 16% | 2.03 | 0.70 | 0.60 | 17 | 10 |
| Grindamyl Powerbake | 100 | 90 min | 2.37 | 27% | 2.24 | 0.68 | 0.59 | 15 | 10 |
| Grindamyl Powerbake | 100 | 150 min | 2.74 | 47% | 2.58 | 0.68 | 0.58 | 13 | 8 |

C-AXOS: content of AXOS expressed as g/l;
AXOS_{cor}: content of AXOS corrected for arabinogalactan, expressed as g/l;
A/X AXOS: arabinose to xylose ratio of AXOS;
A/X_{cor} AXOS: arabinose to xylose ratio of AXOS, corrected for arabinogalactan;
avDP AXOS: average degree of polymerisation of AXOS;
avDP Xylan: average degree of polymerisation of the xylan backbone of AXOS.

TABLE 3
Analysis of barley malt worts produced in presence of different endoxylanase preparations.

| | Enzyme | C-AXOS | % increase in | C-AXOS_{cor} | A/X | A/X_{cor} | avDP | avDP |
|---|---|---|---|---|---|---|---|---|
| Enzyme | dose (Units/l) | (g/l) | C-AXOS | (g/l) | AXOS | AXOS | AXOS | Xylan |
| None | 0 | 2.00 | 0% | 1.89 | 0.85 | 0.75 | 13 | 7 |
| Grindamyl H640 | 250 | 2.09 | 4% | 2.00 | 0.80 | 0.71 | 13 | 7 |
| Grindamyl H640 | 500 | 2.13 | 6% | 2.04 | 0.80 | 0.73 | 13 | 7 |
| Grindamyl H190 | 500 | 2.07 | 3% | 1.95 | 0.82 | 0.74 | 13 | 7 |
| Grindamyl Powerbake | 250 | 2.66 | 33% | 2.57 | 0.75 | 0.69 | 12 | 7 |
| Shearzyme 500L | 250 | 2.37 | 19% | 2.29 | 0.86 | 0.80 | 6 | 3 |
| Grindamyl Powerbake + | 250 + 62 | 2.83 | 42% | 2.75 | 0.76 | 0.71 | 6 | 4 |
| Shearzyme 500L | | | | | | | | |

C-AXOS: content of AXOS expressed as g/l;
AXOS_{cor}: content of AXOS corrected for arabinogalactan, expressed as g/l;
A/X AXOS: arabinose to xylose ratio of AXOS;
A/X_{cor} AXOS: arabinose to xylose ratio of AXOS, corrected for arabinogalactan;
avDP AXOS: average degree of polymerisation of AXOS;
avDP Xylan: average degree of polymerisation of the xylan backbone of AXOS.

TABLE 4
Analysis of barley malt worts produced in presence of different doses of the thermostable endoxylanase preparation
Ecopulp TX 200A from Trichoderma longibrachiatum.

| | Enzyme dose | C-AXOS | % increase in | C-AXOS_{cor} | A/X | A/X_{cor} | avDP | avDP |
|---|---|---|---|---|---|---|---|---|
| Enzyme | (Units/l) | (g/l) | C-AXOS | (g/l) | AXOS | AXOS | AXOS | Xylan |
| None | 0 | 1.54 | 0% | 1.48 | 0.83 | 0.76 | 16 | 9 |
| Ecopulp TX200A | 400 | 2.55 | 66% | 2.48 | 0.67 | 0.63 | 13 | 8 |
| Ecopulp TX200A | 600 | 2.78 | 81% | 2.71 | 0.64 | 0.60 | 11 | 7 |
| Ecopulp TX200A | 2500 | 3.52 | 129% | 3.45 | 0.58 | 0.55 | 9 | 6 |
| Ecopulp TX200A | 5000 | 3.69 | 140% | 3.61 | 0.58 | 0.55 | 10 | 6 |
| Ecopulp TX200A + Shearzyme 500L | 2500 + 62 | 3.63 | 136% | 3.56 | 0.60 | 0.57 | 8 | 5 |

C-AXOS: content of AXOS expressed as g/l;
AXOS_{cor}: content of AXOS corrected for arabinogalactan, expressed as g/l;
A/X AXOS: arabinose to xylose ratio of AXOS;
A/X_{cor} AXOS: arabinose to xylose ratio of AXOS, corrected for arabinogalactan;
avDP AXOS: average degree of polymerisation of AXOS;
avDP Xylan: average degree of polymerisation of the xylan backbone of AXOS.

TABLE 5
Analysis of barley malt worts with or without addition of wheat
bran or rye bran in presence or absence of the thermostable endoxylanase preparation
Ecopulp TX 200A from Trichoderma longibrachiatum.

| | | | | | C- | | | | |
|---|---|---|---|---|---|---|---|---|---|
| | Enzyme | | C-AXOS | % increase | AXOS_{cor} | A/X | A/X_{cor} | avDP | avDP |
| Enzyme | dose (Units/l) | Mash composition | (g/l) | in C-AXOS | (g/l) | AXOS | AXOS | AXOS | Xylan |
| None | 0 | malt | 1.61 | 0% | 1.50 | 0.81 | 0.69 | 11 | 6 |
| Ecopulp TX200A | 4000 | malt | 2.16 | 34% | 2.06 | 0.58 | 0.51 | 7 | 5 |
| None | 0 | malt + wheat bran | 1.68 | 0% | 1.50 | 0.82 | 0.63 | 19 | 10 |
| Ecopulp TX200A | 4000 | malt + wheat bran | 4.02 | 139% | 3.63 | 0.55 | 0.40 | 6 | 4 |
| None | 0 | malt + rye bran | 2.02 | 0% | 1.71 | 0.62 | 0.54 | 23 | 14 |
| Ecopulp TX200A | 4000 | malt + rye bran | 3.59 | 78% | 3.34 | 0.59 | 0.50 | 6 | 4 |

C-AXOS: content of AXOS expressed as g/l;
AXOS_{cor}: content of AXOS corrected for arabinogalactan, expressed as g/l;
A/X AXOS: arabinose to xylose ratio of AXOS;
A/X_{cor} AXOS: arabinose to xylose ratio of AXOS, corrected for arabinogalactan;
avDP AXOS: average degree of polymerisation of AXOS;
avDP Xylan: average degree of polymerisation of the xylan backbone of AXOS.

TABLE 6
Analysis of worts A and B and corresponding beers A and B. Wort A was made on the basis of 100% barley malt without
added endoxylanase, while wort B was made on the basis of 90% barley malt and 10% rye bran in the presence of the
thermostable endoxylanase preparation Ecopulp TX 200A from Trichoderma longibrachiatum.

| | | | | | | % | | | | | |
|---|---|---|---|---|---|---|---|---|---|---|---|
| | | real | original | | C- | increase | C- | | | | |
| | alcohol | extract | extract | Maltodextrins | AXOS | in C- | AXOS_{cor} | A/X | A/X_{cor} | avDP | avDP |
| | (% v/v) | (g/100 ml) | (g/100 ml) | (g/l) | (g/l) | AXOS | (g/l) | AXOS | AXOS | AXOS | Xylan |
| wort A | N.D. | N.D. | N.D. | 94 | 1.06 | 0% | 0.98 | 0.76 | 0.63 | N.D. | N.D. |
| wort B | N.D. | N.D. | N.D. | 95 | 3.40 | 221% | 3.29 | 0.50 | 0.45 | N.D. | N.D. |
| beer A | 4.3 | 3.9 | 10.8 | 26 | 0.95 | 0% | 0.88 | 0.76 | 0.64 | 15 | 8 |
| beer B | 5.1 | 4.2 | 12.5 | 24 | 3.53 | 272% | 3.34 | 0.47 | 0.43 | 6 | 4 |
| light beer A | 2.3 | 2.1 | 5.9 | 12 | 0.88 | 0% | 0.84 | 0.53 | 0.47 | 11 | 7 |
| light beer B | 2.6 | 2.1 | 6.3 | 13 | 1.93 | 119% | 1.87 | 0.47 | 0.43 | 6 | 4 |

C-AXOS: content of AXOS expressed as g/l;
AXOS_{cor}: content of AXOS corrected for arabinogalactan, expressed as g/l;
A/X AXOS: arabinose to xylose ratio of AXOS;
A/X_{cor} AXOS: arabinose to xylose ratio of AXOS, corrected for arabinogalactan;
avDP AXOS: average degree of polymerisation of AXOS;
avDP Xylan: average degree of polymerisation of the xylan backbone of AXOS.

TABLE 7
Analysis of control beer and experimental beer with addition of AXOS-5-0.5.

| | | real | | | C- | | C- | | |
|---|---|---|---|---|---|---|---|---|---|
| | alcohol | extract | original extract | Maltodextrins | AXOS | % increase | AXOS_{cor} | A/X | A/X_{cor} |
| | (% v/v) | (g/100 ml) | (g/100 ml) | (g/l) | (g/l) | in C-AXOS | (g/l) | AXOS | AXOS |
| control beer | 2.77 | 2.23 | 6.72 | 17.05 | 1.12 | 0% | 1.09 | 0.65 | 0.57 |
| experimental beer | 2.69 | 2.39 | 6.75 | 15.40 | 2.81 | 151% | 2.78 | 0.52 | 0.50 |

C-AXOS: content of AXOS expressed as g/l;
AXOS_{cor}: content of AXOS corrected for arabinogalactan, expressed as g/l;
A/X AXOS: arabinose to xylose ratio of AXOS;
A/X_{cor} AXOS: arabinose to xylose ratio of AXOS, corrected for arabinogalactan.

All publications and patent applications mentioned in this specification are herein incorporated by reference.
Other embodiments are within the following claims.

What is claimed is:

1. A beer comprising less than 3.5% (v/v) alcohol or less than 3 g per 100 ml real extract, said beverage comprising more than 1.2 g and up to 20 g per litre beer of soluble arabinoxylans having an average degree of polymerisation (DP) below 50.

2. A bottom fermented beer comprising an alcohol level between 3.5 and 6% (v/v) and a real extract between 3 and 5 g per 100 ml, said beer comprising at least 3.5 g and up to 25 g per litre beer of soluble arabinoxylans having an average degree of polymerisation (DP) below 50.

3. A beer comprising more than 6% (v/v) alcohol and a real extract of at least 5 g per 100 ml, said beer comprising at least 2.4 g and up to 30 g per litre beer of soluble arabinoxylans having an average degree of polymerisation (DP) below 50.

4. The beer of claim 1, being a bottom fermented beer or a top fermented beer.

5. The beer of claim 3, being a bottom fermented beer or a top fermented beer.

6. The beer of claim 1, wherein the soluble arabinoxylans have an average degree of polymerisation of at least 3.

7. The bottom fermented beer of claim 2, wherein the soluble arabinoxylans have an average degree of polymerisation of at least 3.

8. The beer of claim 3, wherein the soluble arabinoxylans have an average degree of polymerisation of at least 3.

9. The beer of claim 1, wherein the soluble arabinoxylans exhibit an arabinose/xylose ratio of at least 0.3.

10. The bottom fermented beer of claim 2, wherein the soluble arabinoxylans exhibit an arabinose/xylose ratio of at least 0.3.

11. The beer of claim 3, wherein the soluble arabinoxylans exhibit an arabinose/xylose ratio of at least 0.3.

12. The beer of claim 1, wherein the soluble arabinoxylans exhibit an arabinose/xylose ratio of at most 0.5.

13. The bottom fermented beer of claim 2, wherein the soluble arabinoxylans exhibit an arabinose/xylose ratio of at most 0.5.

14. The beer of claim 3, wherein the soluble arabinoxylans exhibit an arabinose/xylose ratio of at most 0.5.

15. A method for the production of the beer of claim 1, comprising the steps of:
(i) producing a beer by providing cereal grains and performing, onto said cereal grains, (a) a mashing step, (b) a lautering step, (c) a wort boiling step, (d) a cooling step including inoculation with a micro-organism and (e) a fermentation step to achieve a beer comprising less than 3.5% (v/v) alcohol or less than 3 g per 100 ml real extract, and
(ii) enriching, at any one of steps (a), (b), (c), (d) and (e), the product of said step, with soluble arabinoxylans having an average degree of polymerisation (DP) below 50 until said enrichment results in a final concentration of more than 1.2 g and up to 20 g of said soluble arabinoxylans per litre beer.

16. A method for the production of the bottom fermented beer of claim 2, comprising the steps of:
(i) brewing a beer by providing cereal grains and performing onto said cereal grains (a) a mashing step, (b) a lautering step, (c) a wort boiling step, (d) a cooling step including inoculation with a micro-organism and (e) a fermentation step to achieve a bottom fermented beer comprising between 3.5% and 6% (v/v) alcohol and a real extract between 3 and 5 g per 100 ml, and
(ii) enriching at any one of steps (a), (b), (c), (d) and (e), the product of said step with soluble arabinoxylans having an average degree of polymerisation (DP) below 50 until said enrichment results in a final concentration of at least 3.5 g and up to 25 g of said soluble arabinoxylans per litre beer.

17. A method for the production of the beer of claim 3, comprising the steps of:
(i) brewing a beer by providing cereal grains and performing onto said cereal grains (a) a mashing step, (b) a lautering step, (c) a wort boiling step, (d) a cooling step including inoculation with a microorganism and (e) a fermentation step to achieve a beer comprising more than 6% (v/v) alcohol and a real extract of at least 5 g per 100 ml, and
(ii) enriching at any one of steps (a), (b), (c), (d) and (e), the product of said step with soluble arabinoxylans having an average degree of polymerisation (DP) below 50 until said enrichment results in a final concentration of at least 2.4 g and up to 30 g of said soluble arabinoxylans per litre beer.

18. The method of claim 15, wherein said micro-organism is a yeast.

19. The method of claim 15, further comprising, prior to the mashing step, performing a malting step onto said cereal grains.

20. The method of claim 15, wherein the enriching step (ii) comprises the addition of one or more endoxylanases at any one of steps (a) and (b).

21. The method of claim 15, wherein the enriching step (ii) comprises the addition of one or more endoxylanases at any one of steps (a) and (b) to result in an increase by at least 30% of the soluble arabinoxylan content with respect to a wort prepared in absence of any added endoxylanase.

22. The method of claim 15, wherein the enriching step (ii) comprises the addition of a non-inhibited endoxylanase or a thermostable endoxylanase or a glycoside hydrolase family 11-endoxylanase at any one of steps (a) and (b).

23. The method of claim 16, wherein the enriching step (ii) comprises the addition of one or more endoxylanases at any one of steps (a) and (b).

24. The method of claim 16, wherein the enriching step (ii) comprises the addition of one or more endoxylanases at any one of steps (a) and (b) to result in an increase by at least 30% of the soluble arabinoxylan content with respect to a wort prepared in absence of any added endoxylanase.

25. The method of claim 16, wherein the enriching step (ii) comprises the addition of a non-inhibited endoxylanase or a thermostable endoxylanase or a glycoside hydrolase family 11-endoxylanase at any one of the steps (a) and (b).

26. The method of claim 17, wherein the enriching step (ii) comprises the addition of one or more endoxylanases at any one of steps (a) and (b).

27. The method of claim 17, wherein the enriching step (ii) comprises the addition of one or more endoxylanases at any one of steps (a) and (b) to result in an increase by at least 30% of the soluble arabinoxylan content with respect to a wort prepared in absence of any added endoxylanase.

28. The method of claim 17, wherein the enriching step (ii) comprises the addition of a non-inhibited endoxylanase or a thermostable endoxylanase or a glycoside hydrolase family 11-endoxylanase at any one of steps (a) and (b).

29. The method of claim 15, wherein the enrichment step (ii) comprises the addition of one or more endoxylanases at any one of the steps (a) and (b) and adding a material containing at least 15% by weight of water non-extractable arabinoxylans to the product of any one of steps (a) and (b).

30. The method of claim 16, wherein the enrichment step (ii) comprises the addition of one or more endoxylanases at any one of the steps (a) and (b) and adding a material containing at least 15% by weight of water non-extractable arabinoxylans to the product of any one of steps (a) and (b).

31. The method of claim 17, wherein the enrichment step (ii) comprises the addition of one or more endoxylanases at any one of the steps (a) and (b) and adding a material containing at least 15% by weight of water non-extractable arabinoxylans to the product of any one of steps (a) and (b).
